(19) United States
(12) Patent Application Publication
(10) Pub. No.: US 2021/0206335 A1
(43) Pub. Date: Jul. 8, 2021

(54) PASSENGER-SIDE AIRBAG

(71) Applicant: JOYSON SAFETY SYSTEMS JAPAN K.K., Tokyo (JP)

(72) Inventors: Shinichi TAKEUCHI, Echi-gun (JP); Norihisa OKADA, Echi-gun (JP); Kai YASUDA, Echi-gun (JP)

(73) Assignee: JOYSON SAFETY SYSTEMS JAPAN K.K., Tokyo (JP)

(21) Appl. No.: 17/058,806

(22) PCT Filed: Jul. 30, 2019
(86) PCT No.: PCT/JP2019/029763

§ 371 Date: Nov. 25, 2020

(30) Foreign Application Priority Data
Aug. 30, 2018 (JP) 2018-161694

(51) Int. Cl. B60R 21/205; B60R 21/2338

(52) U.S. Cl. CPC B60R 21/205; B60R 2021/23382; B60R 21/2338

(57) ABSTRACT

When the passenger-side airbag 1 is inflated fully, vertically-extending recesses 8, 9 are formed in left and right sides of an occupant-facing surface 2. A protrusion 10 between the recesses 8 and 9 restrains a head portion of an occupant, and the left and right protrusions 11, 12 restrains shoulders. In the case where a small occupant is restrained, the recesses 8, 9 remain.

### TECHNICAL FIELD

The present invention relates to a passenger-side airbag, and more specifically to a passenger-side airbag that, when fully inflated, has a vertically-extending recess formed in an occupant-facing surface. In the following description, directions such as front/rear (forward/rearward), left/right (lateral), and upper/lower (upward/downward) (vertical) respectively coincide with the directions toward the front/rear, left/right, top/bottom of an automobile equipped with a passenger-side airbag.

### BACKGROUND ART

PTL 1 describes a passenger-side airbag that, when fully inflated, has a recess that extends vertically across an occupant-facing surface, and a protrusion formed on each of the left and right sides of the recess. The passenger-side airbag includes a peripheral panel that extends from an upper surface of the passenger-side airbag in the fully inflated state to a lower surface of the airbag via the occupant-facing surface, and a pair of side panels defining the left and right sides of the airbag. The airbag includes a tether provided in such a way as to couple the occupant-facing surface to the front portion of the airbag. Due to the presence of the tether, a recess is formed that extends vertically across the central portion of the occupant-facing surface, and a protrusion is formed on each side of the recess.

PTL 2 describes a passenger-side airbag including vertically-extending first protrusions provided at opposite left and right side edges of an occupant-facing surface, and three vertically-extending second protrusions provided in a portion of the occupant-facing surface between the first protrusions. The second protrusions protrude toward the occupant by a smaller height than do the first protrusions. The space between the protrusions defines a recess that extends vertically.

### CITATION LIST

### Patent Literature

PTL 1: JP 2012-56371 A

PTL 2: US 2018/0126946 A1

### SUMMARY OF INVENTION

### Technical Problem

An object of the present invention is to provide a passenger-side airbag that ensures that upon restraining a small occupant, the small occupant receives a small reaction force, and upon restraining a large occupant, the large occupant receives a large reaction force.

### Solution to Problem

A passenger-side airbag of the present invention comprises an occupant-facing surface facing an occupant in an inflated and deployed state, wherein in the inflated and deployed state, the occupant-facing surface has a first recess, a second recess, and a first protrusion, the first and second recesses being respectively provided in left side and right side portions of the occupant-facing surface and extending in a vertical direction, the first protrusion being defined between the first and second recesses.

In one aspect of the present invention, the occupant-facing surface has a second protrusion located leftward of the first recess, and a third protrusion located rightward of the second recess, and the first protrusion is flush with or recedes forward relative to the second and third protrusions.

In one aspect of the present invention, the passenger-side airbag comprises a tether that pulls the occupant-facing surface forward to form each of the recesses.

In one aspect of the present invention, the tether comprises an upper tether and a lower tether, the upper tether being coupled to an upper portion of each of the recesses, the lower tether being coupled to a lower portion of each of the recesses.

In one aspect of the present invention, the passenger-side airbag comprises a panel that defines the occupant-facing surface, wherein the panel includes a tuck, and a rear end of the tether is connected to the tuck.

In one aspect of the present invention, the tuck has a uniform fold-in width along the vertical direction.

In one aspect of the present invention, at least a portion of the tuck in the vertical direction has a different fold-in width from another portion.

In one aspect of the present invention, the panel has an upper side that extends in a lateral direction along an upper portion of the occupant-facing surface, wherein the upper side includes a cut provided in at least one of an area located leftward of the first recess and an area located rightward of the second recess, and wherein the cut has a left side edge and a right side edge that are sewn onto each other.

In one aspect of the present invention, the first recess and the second recess extend in parallel to each other.

In one aspect of the present invention, the first recess and the second recess have a spacing from each other that decreases toward a lower area.

In one aspect of the present invention, the inflated and deployed state of the passenger-side airbag, in the first recess and the second recess have a spacing of 150 to 350 mm from each other in a middle portion in the vertical direction of the occupant-facing surface, and in the middle portion, the first recess and the second recess have a depth of 100 to 200 mm.

In one aspect of the present invention, the tether includes a perforated slit, and once inflation is complete, the tether breaks along the slit and increases in length.

In one aspect of the present invention, the first protrusion comprises only a single protrusion defined between the first recess and the second recess.

### Advantageous Effects of Invention

When the passenger-side airbag according to the present invention is fully inflated, vertically-extending recesses are formed in opposite left and right side portions of the occupant-facing surface, and a first protrusion is formed between these recesses. When the first protrusion restrains the head of the occupant, the head is pushed into the first protrusion.

If the occupant is of a small size, the occupant's head is pushed in to a small depth such that the recesses remain. Thus, the head receives a small reaction force from the airbag. If the occupant is of a large size, the occupant's head is pushed in to a large depth, so that the head is pushed all the way in to a location forward of the deepest portion of each recess. Consequently, the recesses no longer remain in the occupant-facing surface. This causes an increased tension to be applied to the panel against which the occupant's head is striking. The occupant's head thus receives an increased reaction force from the airbag.

### BRIEF DESCRIPTION OF DRAWINGS

FIG. 1 is a perspective view of a passenger-side airbag according to an embodiment, illustrating the shape of the airbag when inflated.

FIG. 2 is a side view of the passenger-side airbag according to the embodiment with the airbag inflated in the vehicle interior.

FIG. 3 is a sectional view taken along a line of FIG. 2.

FIG. 4 is an exploded perspective view of the passenger-side airbag according to the embodiment.

FIG. 5 illustrates the structure of panels of the passenger-side airbag according to the embodiment.

FIGS. 6a and 6b are plan views of the passenger-side airbag according to the embodiment, illustrating restraining of an AF05 occupant by the airbag.

FIGS. 7a and 7b are plan views of the passenger-side airbag according to the embodiment, illustrating restraining of an AM50 occupant by the airbag.

FIGS. 8a and 8b are plan views of the passenger-side airbag according to the embodiment, illustrating restraining of the AM50 occupant by the airbag.

### DESCRIPTION OF EMBODIMENTS

An embodiment will be described below with reference to the drawings.

As illustrated in FIG. 2, a passenger-side airbag 1 for a passenger seat according to the embodiment is inflated and deployed between an instrument panel P and a windshield W.

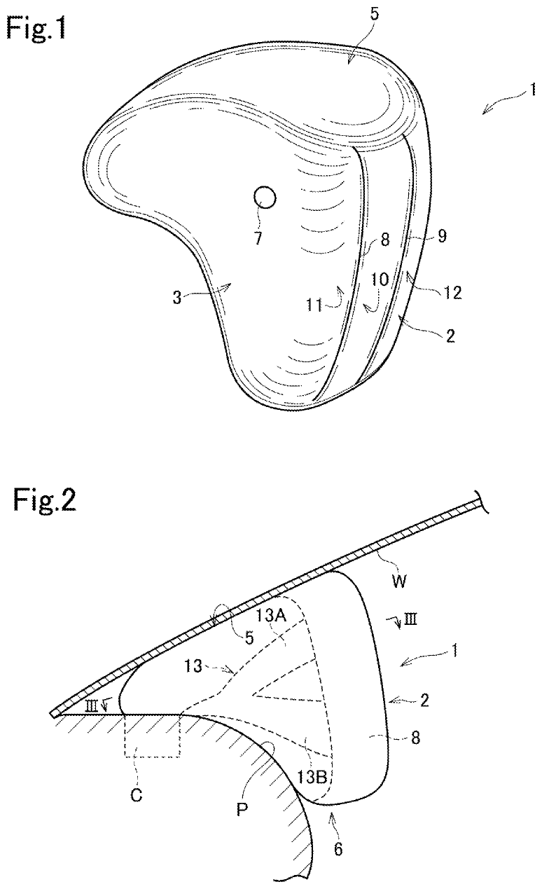

When fully inflated, the passenger-side airbag 1 has an occupant-facing surface 2, left and right side surfaces 3 and 4, an upper surface 5, and a lower surface 6. The side surfaces 3 and 4 each have a vent hole 7 (FIG. 1). In the fully inflated state, the occupant-facing surface 2 has a first recess 8 and a second recess 9, which extend vertically so as to run across the occupant-facing surface 2 from top to bottom, and a central protrusion 10, which is formed between the recesses 8 and 9 and serves as a vertically-extending first protrusion. According to the embodiment, a single central protrusion (first protrusion) 10 is formed between the first recess 8 and the second recess 9.

A left-side protrusion 11, which extends vertically and serves as a second protrusion, is provided to the left of the first recess 8 located at the left side, and a right-side protrusion 12, which extends vertically and serves as a third protrusion, is provided to the right of the second recess 9 located at the right side. The recesses 8 and 9 are formed as the occupant-facing surface 2 is pulled by tethers 13 and 14. The rear ends of the tethers 13 and 14 are respectively sewn onto the recesses 8 and 9. The front ends of the tethers 13 and 14 are sewn onto a patch cloth 15. The patch cloth 15 is sewn onto a peripheral edge portion of an inflator opening 35.

According to the embodiment, each of the tethers 13 and 14 splits into two branches at a location near the occupant. A tether 13A or 14A (reference sign 14A is not shown in the drawings) corresponding to the upper branch is coupled to an upper portion of the recess 8 or 9, and a tether 13B or 14B (reference sign 14B is not shown in the drawings) corresponding to the lower branch is coupled to a lower portion of the recess 8 or 9.

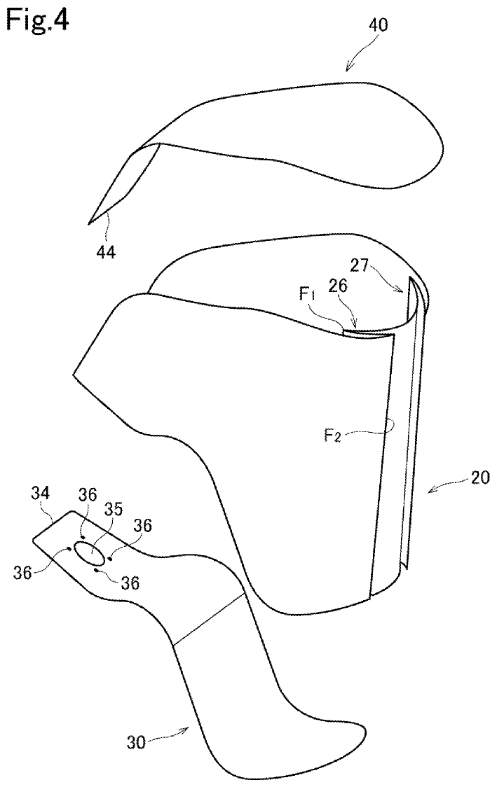

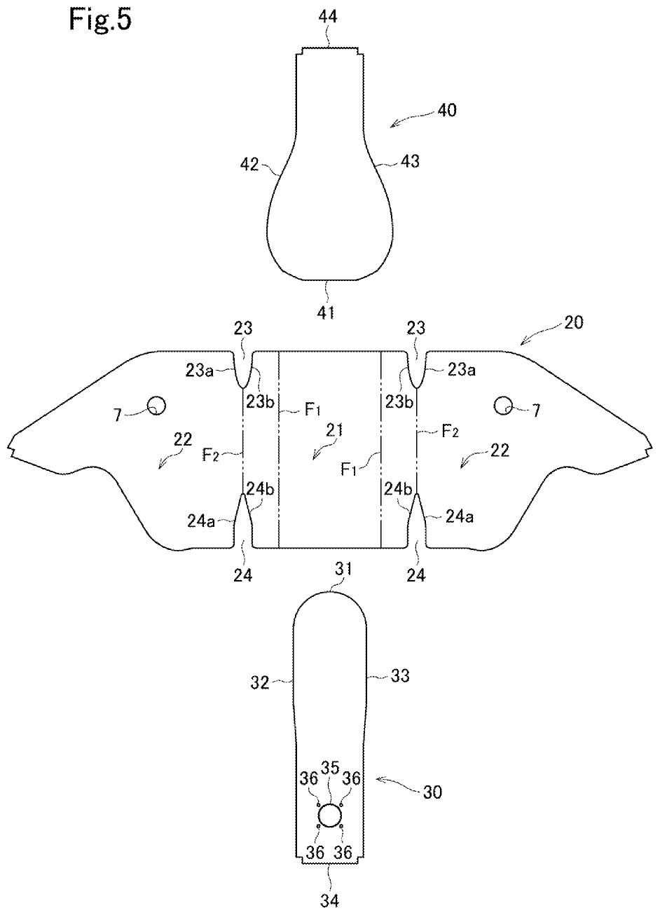

As illustrated in FIGS. 4 and 5, the passenger-side airbag 1 is formed by sewing a main panel 20, a bottom panel 30, and a top panel 40 together.

As illustrated in FIG. 5, the main panel 20 has a laterally central portion 21 that defines the occupant-facing surface 2, and left and right side portions 22 that respectively define the left and right side surfaces 3 and 4. The central portion 21 has a first fold line Fi set at a location near each of the left and right side portions 22 such that the first fold line Fi runs vertically.

The main panel 20 includes substantially V-shaped cuts 23 and 24 respectively provided in its upper and lower sides and located near the boundary area between the central portion 21 and the left and right side portions 22.

The top panel 40 has a rear side 41, a left side 42, a right side 43, and a front side 44.

The bottom panel 30 has a rear side 31, a left side 32, a right side 33, and a front side 34. The inflator opening 35 is provided near the front portion of the bottom panel 30. The patch cloth 15 is sewn onto the periphery of the inflator opening 35. The patch cloth 15 is also provided with an inflator opening. Multiple (e.g., four) small holes 36 through which to pass an inflator-mounting bolt are provided so as to penetrate the bottom panel 30 and the patch cloth 15.

A left side edge 23a and a right side edge 23b of the cut 23 provided in the upper side of the main panel 20 are sewn together, and side edges 24a and 24b of the cut 24 provided in the lower side of the main panel 20 are sewn together. Further, the main panel 20 is folded along the fold line F₁ and a fold line F₂ as illustrated in FIG. 4.

The upper side of the main panel 20, and the sides 41, 42, and 43 of the top panel 40 are sewn together.

The lower side of the main panel 20, and the sides 31, 32, and 33 of the bottom panel 30 are sewn together. Further, the front side 44 of the top panel 40, and the front side 34 of the bottom panel 30 are sewn together.

By folding back the main panel 20 along the fold lines F₁ and F₂ in this way, tucks 26 and 27 are formed in left and right side portions of the occupant-facing surface 2 as illustrated in FIG. 4. The rear ends of the tethers 13 and 14 are respectively sewn onto areas near the fold lines F₁ of the tucks 26 and 27, and the front edges of the tethers 13 and 14 are sewn onto the patch cloth 15.

As the airbag 1 inflates, the tethers 13 and 14 pull the tucks 26 and 27 toward the front of the vehicle, and thus the recesses 8 and 9 are formed.

After the panels 20, 30, and 40 are sewn together as described above, the airbag 1 are turned inside out through the inflator opening 35, and thus made into its final product form with the seam allowance area between the panels and the tucks being positioned inside the airbag 1.

The passenger-side airbag 1 is of simple construction and is easy to sew, and also allows for reduced total panel weight. Due to the absence of any partition wall that divides the interior of the airbag 1 into left and right sections, gas from the inflator is allowed to quickly flow throughout the entire interior of the airbag 1.

An inflator is attached to the airbag 1. The resulting airbag 1 is folded up, placed inside a box-shaped case C (FIG. 2), and installed into the case by use of an inflator-mounting bolt. A lid (not illustrated) is provided to the instrument panel P such that the lid covers the airbag 1 that has been folded up. The folded-up airbag 1, the inflator, and the case C constitute a passenger-side airbag device. The lid may be provided as a portion of the instrument panel, or may be provided as a cover-like component that is separate from the instrument panel. In the latter case, the lid is coupled to the case.

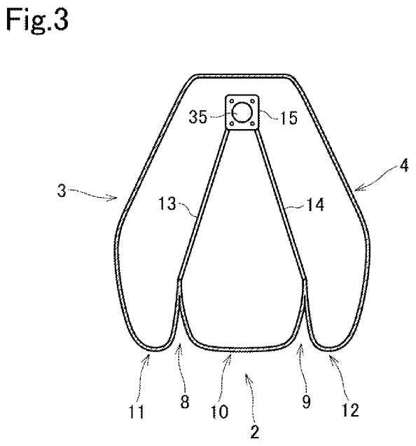

Upon activation of the inflator, the airbag 1 pushes the lid open and, as illustrated in FIGS. 1 to 3, the airbag 1 deploys in front of the passenger-seat occupant between the instrument panel P and the windshield W to thereby restrain the occupant.

In the fully inflated state of the airbag 1, the occupant-facing surface 2 has a substantially rectangular shape in rear view of the passenger-side airbag 1. As the occupant-facing surface 2 is pulled by the tether 13, the vertically-extending recesses 8 and 9 are formed in the occupant-facing surface 2, and the vertically-extending protrusions 10, 11, and 12 are formed, the protrusion 10 being located between the recesses 8 and 9, the protrusion 11 being located to the left of the recess 8, the protrusion 12 being located to the right of the recess 9.

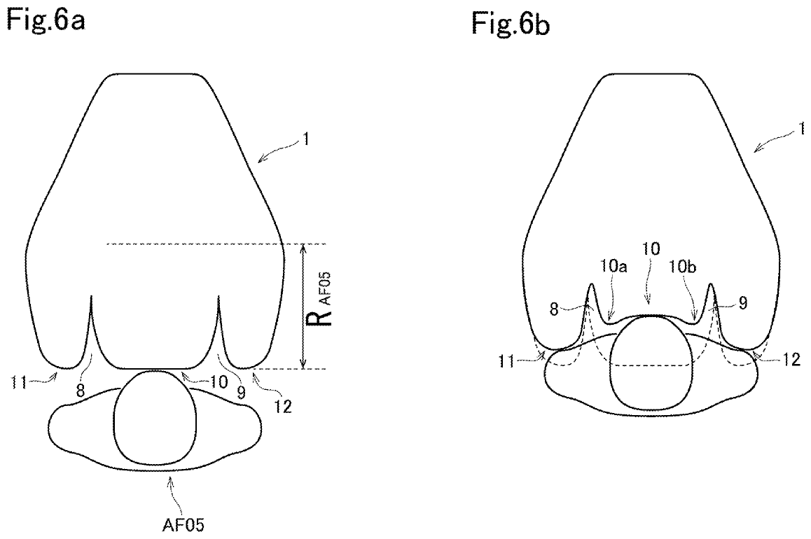

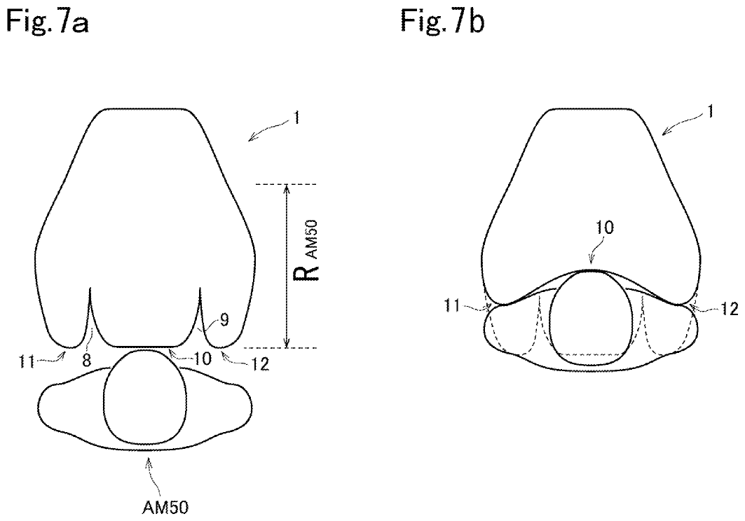

As illustrated in FIGS. 6a and 6b or FIGS. 7a and 7b, during a vehicle collision, the left and right shoulder portions of the occupant's upper body are respectively restrained by the protrusions 11 and 12. The head and chest portions of the occupant are restrained by the protrusion 10.

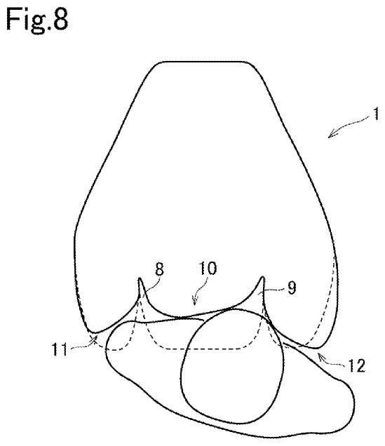

With the airbag 1, in a right-oblique collision of the vehicle (a type of collision in which impact is applied from the right-front of the vehicle, examples of which include an offset collision), the occupant is received by the right-side protrusion 12 as illustrated in FIG. 8, and in a left-oblique collision of the vehicle, the occupant is received by the left-side protrusion 11.

As illustrated in FIG. 6b, if the passenger-side airbag 1 is to restrain a small occupant (typically represented by AF05), the occupant's head is received by the protrusion 10, and the head moves in such a way as to push the occupant-facing surface forward. The occupant's shoulders are restrained by the protrusions 11 and 12. Symbol R_{AF05} in FIG. 6a represents the restraint region for the AF05 occupant.

In the case of a small occupant, the occupant's head and shoulders push into the protrusions 10, 11, and 12 to a depth less than the initial depth of the recesses 8 and 9. Thus, as illustrated in FIG. 6b, even with the small occupant pushing into the protrusions 10, 11, and 12, the recesses 8 and 9 remain in the occupant-facing surface 2. At this time, opposite side portions 10a and 10b of the protrusion 10, which are located to the left and right of the occupant's head, are curved so as to protrude rearward. As a result, the occupant's head receives a relatively small reaction force from the airbag 1. Since the recesses 8 and 9 remain as described above, the head of the small occupant receives a reaction force from the airbag 1 that is smaller than the reaction force that the head of the small occupant would receive from a conventional airbag with no recesses 8 and 9.

As illustrated in FIG. 7b, if the passenger-side airbag 1 is to restrain a large occupant (typically represented by AM50), the occupant is restrained in such a way that the occupant's head pushes deeply into the protrusion 10, and that the occupant's shoulders push deeply into the protrusions 11 and 12. Symbol R_{AM05} in FIG. 7a represents the restraint region for the AM05 occupant.

In this case, the depth to which the occupant's head pushes into the protrusion 10, and the depth to which the occupant's shoulders push into the protrusions 11 and 12 are greater than the initial depth of the recesses 8 and 9. This causes the recesses 8 and 9 to disappear from the occupant-facing surface 2. At this time, the occupant's head pushes into the protrusion 10 to a depth greater than the depth to which the occupant's shoulders push into the protrusions 11 and 12. As illustrated in FIG. 7b, this cause the occupant-facing surface 2 to become stretched tight under high tension from the head restraint region located in its laterally central portion to the shoulder restraint regions located at the left and right sides. Consequently, the occupant's head receives a large reaction force from the occupant-facing surface 2.

As described above, the passenger-side airbag 1 ensures, without changing the internal pressure of the airbag, that the larger the size of the occupant, the greater the reaction force that the occupant's head receives from the airbag.

In the fully inflated state prior to restraining of the occupant, the spacing between the recesses 8 and 9 (the mean distance between the deepest portions of the recesses 8 and 9) is preferably about 150 to 380 mm, particularly preferably 250 to 380 mm. In this state, the recesses 8 and 9 each have, near its vertically middle portion, a depth of preferably about 100 to 200 mm, particularly preferably 150 to 200 mm.

The recesses 8 and 9 may or may not be of substantially uniform depth along the vertical direction. For example, the recesses 8 and 9 may be formed so as to be deeper in at least one of upper and lower portions than in the other portion.

In the embodiment above, the recesses 8 and 9 are provided in the occupant-facing surface 2 such that the recesses 8 and 9 extend vertically in parallel to each other. Alternatively, the recesses 8 and 9 may be provided such that their spacing decreases toward the lower portion of the occupant-facing surface 2.

In the embodiment above, the main panel 20 includes the cuts 23 and 24 respectively provided in its upper and lower sides. Alternatively, the main panel 20 may include a cut provided only in its upper side. Still alternatively, the main panel 20 may include a cut provided only at one of the left and right sides.

In FIGS. 6a and 7a, in the fully inflated state, the protrusion 10 at the center, and the protrusions 11 and 12 on the left and right are substantially flush with each other. Alternatively, the protrusion 10 may recede toward the front of the vehicle relative to the protrusions 11 and 12. Still alternatively, one of the protrusions 11 and 12 may recede toward the front of the vehicle relative to the other, and the protrusion 10 at the center may further recede toward the front of the vehicle relative to the one of the protrusions 11 and 12.

In an alternative configuration of the present invention, there may be provided a mechanism that changes the opening of the vent hole in accordance with the state of airbag inflation, or increases the opening of the vent hole in response to restraining of the occupant by the airbag.

The embodiment above is only one exemplary embodiment of the present invention, and the present invention may be practiced in ways other than those illustrated in the drawings. For example, although in the embodiment above the main panel 20 is formed by a single continuous panel from the left end side to the right end side, the main panel may be formed by joining two or more panels together by sewing or other methods.

In an alternative configuration of the present invention, the tether may have a perforated slit, and once inflation is complete, the tether may break along the slit and increase in length.

Although specific aspects of the present invention have been described herein in detail, it will be apparent to those skilled in the art that other modifications may be made without departing from the spirit and scope of the present invention.

This application is based on Japanese Patent Application No. 2018-161694 filed Aug. 30, 2018, the entire content of which is incorporated herein by reference.

### REFERENCE SIGNS LIST

1 airbag
2 occupant-facing surface
3, 4 side surface
5 upper surface
6 lower surface
8 first recess
9 second recess
10 first protrusion
11 second protrusion
12 third protrusion
10, 11, 12 protrusion
13, 13A, 13B tether
20 main panel
23, 24 cut
30 bottom panel
35 inflator opening
40 top panel

1. A passenger-side airbag comprising an occupant-facing surface facing an occupant in an inflated and deployed state,
wherein in the inflated and deployed state, the occupant-facing surface has a first recess, a second recess, and a first protrusion, the first and second recesses being respectively provided in left side and right side portions of the occupant-facing surface and extending in a vertical direction, the first protrusion being defined between the first and second recesses.

2. The passenger-side airbag according to claim 1, wherein the occupant-facing surface has a second protrusion located leftward of the first recess, and a third protrusion located rightward of the second recess, and the first protrusion is flush with or recedes forward relative to the second and third protrusions.

3. The passenger-side airbag according to claim 1, comprising a tether that pulls the occupant-facing surface forward to form each of the recesses.

4. The passenger-side airbag according to claim 3, wherein the tether comprises an upper tether and a lower tether, the upper tether being coupled to an upper portion of each of the recesses, the lower tether being coupled to a lower portion of each of the recesses.

5. The passenger-side airbag according to claim 3, comprising a panel that defines the occupant-facing surface,
wherein the panel includes a tuck, and a rear end of the tether is connected to the tuck.

6. The passenger-side airbag according to claim 5, wherein the tuck has a uniform fold-in width along the vertical direction.

7. The passenger-side airbag according to claim 5, at least a portion of the tuck in the vertical direction has a different fold-in width from another portion.

8. The passenger-side airbag according to claim 5,
wherein the panel has an upper side that extends in a lateral direction along an upper portion of the occupant-facing surface,
wherein the upper side includes a cut provided in at least one of an area located leftward of the first recess and an area located rightward of the second recess, and wherein the cut has a left side edge and a right side edge that are sewn onto each other.

9. The passenger-side airbag according to claim 1, wherein the first recess and the second recess extend in parallel to each other.

10. The passenger-side airbag according to claim 1, wherein the first recess and the second recess have a spacing from each other that decreases toward a lower area.

11. The passenger-side airbag according to claim 1,
wherein in the inflated and deployed state of the passenger-side airbag, the first recess and the second recess have a spacing of 150 to 350 mm from each other in a middle portion in the vertical direction of the occupant-facing surface, and
wherein in the middle portion, the first recess and the second recess have a depth of 100 to 200 mm.

12. The passenger-side airbag according to claim 3, wherein the tether includes a perforated slit, and once inflation is complete, the tether breaks along the slit and increases in length.

13. The passenger-side airbag according to claim 1, wherein the first protrusion comprises only a single protrusion defined between the first recess and the second recess.
